(19) United States
(12) Patent Application Publication
(10) Pub. No.: US 2006/0187317 A1
(43) Pub. Date: Aug. 24, 2006

(54) Systems and methods for processing images with positional data

(75) Inventors: Louis J. Montulli, Reno, NV (US); James H. Clark, Redwood City, CA (US); Jeffrey N. Whitehead, San Jose, CA (US); Jason F. Harrison, San Jose, CA (US); Aleksander K, Totic, San Francisco, CA (US); Garrett A. Blythe, Cuppertino, CA (US)

Correspondence Address: TRAN & ASSOCIATES, 6768 MEADOW VISTA CT., SAN JOSE, CA, 95135, US

(73) Assignee: Memory Matrix, Inc.

(21) Appl. No.: 11/064,260

(22) Filed: Feb. 24, 2005

(51) Int. Cl. H04N 5/76

(52) U.S. Cl. 348/231.5

(57) ABSTRACT

Systems and methods are disclosed for annotating a digital photograph by electronically capturing the digital photograph into a digital camera file; receiving a position coordinate; appending the position coordinate to the digital camera file and displaying the digital photograph based on the position coordinate.

### BACKGROUND

The invention relates generally to a system for communicating data including global-positioning-encoded information

Availability of up-to-date information is more important today than ever before and this will continue to be true for the foreseeable future. People want to be well informed, so much so that they travel with cellular phones, beepers, and even portable hand-held Global Positioning System (GPS) satellite receivers.

GPS capable devices generally have a GPS receiver for receiving satellite signals from the GPS satellite network that allow for determination of the device's position. Such devices allow for precisely locating the device in terms of latitude and longitude using the GPS receiver. Some devices have map data stored in memory and a display for showing the device position with reference to the map data. Other devices have no underlying map data base for reference. Rather, they show only the geographic coordinates of the device's location. These coordinates may be referred to as waypoints.

Some GPS receiver devices have the ability to communicate over a telecommunications network. These devices do not provide for automatic or semi-automatic dynamic exchange of on-line position dependent or related information. In addition, these devices cannot communicate with third parties in the absence of a uniform data format standard. For example, a cellular-phone-based system comprising GPS location information working in conjunction with proprietary Public Safety Answering Point (PSAP) telephone equipment is known. The device provides personal and medical information on an emergency basis to the proper authorities. Such a device does not allow third parties to communicate, tag, interrogate, limit, designate, modify or share this information amongst them for any other use.

In a parallel trend, digital cameras have become popular devices for producing high quality digital images of photographic scenes. In general, digital cameras create a digital image by exposure of a CCD sensor array to a photographic scene, followed by conversion of the CCD data to digital image data that is stored in the camera. Thereafter, the digital image data stored in the camera may be transferred to a personal computer or other more permanent storage for printout, viewing, transmission and the like.

One problem with digital image data, however, is the ease with which such data can be manipulated or changed, thereby creating a false representation of the original photographic scene. Such problems are particularly prevalent in certain fields such as forensics and legal or law enforcement fields, where it is essential to prove the authenticity of images. Because of the ease with which digital images may be altered so as to distort the appearance of the original photographic scene, proof of authenticity can often be difficult and sometimes impossible.

Conventional approaches to proving authenticity of digital images have involved the use of public key/private key digital signatures. One such conventional approach is described in U.S. Pat. No. 5,499,294 to Friedman. Friedman's approach involves the use of an embedded private key in a digital camera, with the private key being used to create a digital signature based on a message digest of the image data. Thereafter, a user wishing to authenticate-the image data obtains a public key that corresponds to the embedded private key. As is known in conventional public key/private key authentication, the public key and the private key correspond to each other such that only one public key can decrypt data encrypted with the private key, and vice-versa. Accordingly, through use of the public key, a user of Friedman's system is able to authenticate that image data has not been modified since when it was originally obtained by the digital camera.

U.S. Pat. No. 6,269,446 discloses authentication of image from digital cameras with GPS-derived time and location data. With the wide-spread availability of today's desktop tools and imaging devices, unethical manipulation of digital image data is common, such that digital images are not ordinarily reliable and can be subject to trickery and forgery. In the past, imagery such as photographs and digital images were reliable enough to serve as documentary evidence in most cases, since a skilled craftsman was needed to modify the images and commit fraud. However, skilled craftsmen are no longer needed, and digital images can be modified by even a casual user. Moreover, time data and location data are not ordinarily included in digital images. According to the invention, a digital camera system documents the time, date and location where a digital image was taken, using GPS-derived data from a secure connection. The validity and authenticity of the digital image, as well as the time data and location data, is then protected with a public key signature system that provides a digital signature by which the image and time and location information can be authenticated.

U.S. Pat. No. 6,525,768 discloses a positional camera and GPS data interchange device with a location tagged data provision and display system. A personal communication device (PCD) with electromagnetic communication capability has a GPS receiver and a display. The PCD requests maps and location tagged data from data providers and other for display on the PCD. The data providers respond to requests by using searching and sorting schemes to interrogate data bases and then automatically transmitting data responsive to the requests to the requesting PCD.

### SUMMARY

In one aspect, systems and methods are disclosed for annotating a digital photograph by electronically capturing the digital photograph into a digital camera file; receiving a position coordinate; appending the position coordinate to the digital camera file and displaying the digital photograph based on the position coordinate.

In another aspect, a presentation mechanism graphically shows the location where each photo was taken. In this case a map is displayed with image thumbnails placed at the location where the photo was taken. Location information is extracted from the image meta data or from a separate meta data source.

Advantages of the invention may include one or more of the following. The system enables images to be organized based on location. The improved organization of pictures leads to better and faster searching of images. The location information can also be used to verify the authenticity of the images. The time and location information can facilitate the collation and sharing of photos, for example allowing all the photos of a given time/location (ie, an event) to be shared. Further, the system can compost “panoramas” or create models of a given area when combining the location and the elevation/azimuth information. The system can depict historical change of an area over time, or alternatively, can perform “time lapse” photography without a fixed location. The time-lapse can be done by software in the camera, or in as an external step This technology would facilitate the filming and production of motion picture and television productions, including but not limited to TV news broadcasts, etc. This invention would have application for security and surveillance markets as well.

### BRIEF DESCRIPTION OF THE DRAWINGS

FIG. 1 shows an exemplary embodiment of a GPS enabled camera.

FIG. 2 depicts a block diagram of the camera of FIG. 1.

FIG. 3 is a flow diagram explaining an exemplary process for using position information with images.

### DESCRIPTION

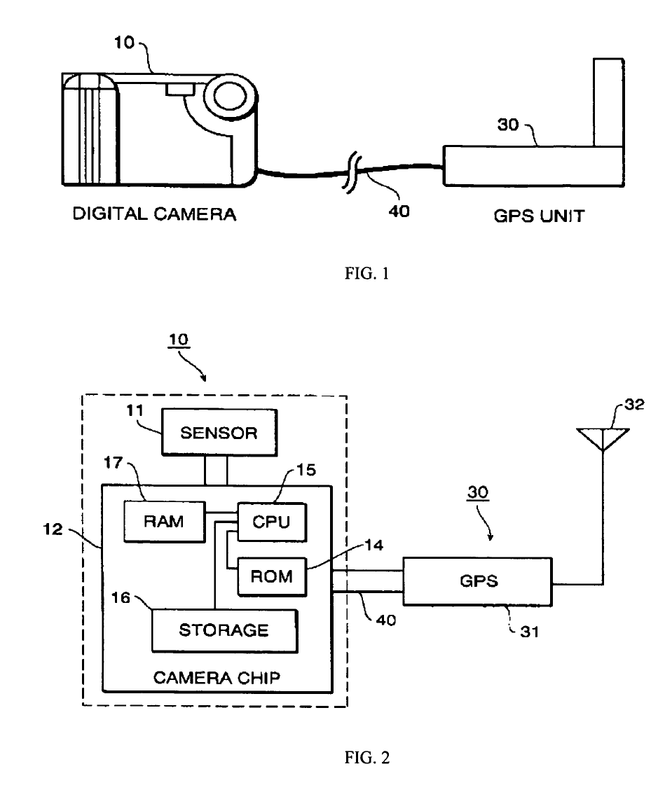

FIG. 1 shows an exemplary embodiment of a GPS enabled camera, in which the location of the image taken is captured along with the image from the digital camera. Specifically, shown in FIG. 1 is a digital camera 10 connected to a GPS unit 30 over a wired or wireless data connection 40. The wireless connection can be done using transceivers compliant with Bluetooth or 801.11 protocol, or any other suitable data transmission protocol.

Digital camera 10 obtains a digital image for a photographic scene by exposing a CCD sensor array to the photographic scene and converting the CCD data into digital data. GPS unit 30 obtains GPS-derived data such as time and location data through conventional triangulation techniques using the GPS grid of orbital satellites. Although the presently-described embodiment illustrates use of GPS unit 30 so as to derive time and location data, the practice of the invention is not limited to a GPS receiver for providing such information, and any now-known or future-developed system for providing time and location data over a secure link to digital camera 10 may also be used.

Alternatively, although FIG. 1 depicts digital camera 10 as a unit separate from GPS unit 30, it is possible to provide an embedded link by incorporating a GPS receiver into digital camera 10 itself, or more preferably on the same chip as the digital camera (also a digital compass and tilt sensor).

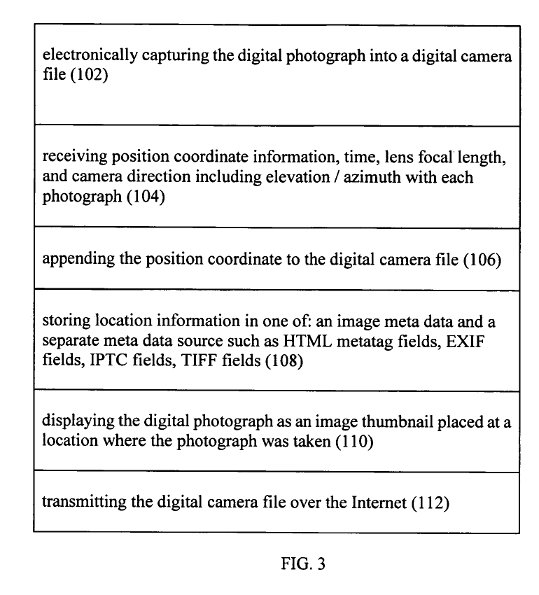

FIG. 2 depicts a block diagram of the camera of FIG. 1. As shown in FIG. 2, digital camera 10 includes a sensor array 11 of CCD sensors which are exposed to a photographic scene through a lens and exposure control system (not shown). Digital camera 10 further includes a camera chip 12 on which are arranged a ROM 14 for storing program instruction sequences that control the digital camera, together with a CPU 15 which executes the program instruction sequences so as to cause the digital camera to expose sensor array 11 to a photographic scene and derive digital image data corresponding to the photographic scene. The digital image data is stored in memory storage section 16. The memory storage section 16 may be removable, so as to facilitate transfer of the digital image data to other devices such as a PC, and/or camera 10 may be provided with an interface (not shown) so as to facilitate transfer of digital image data even if memory storage 16 is not removable. RAM 17 is further provided so as to provide camera 10 with short term and scratch pad random access memory, particularly for use in deriving a digital signature for the digital image. GPS 30 includes a GPS receiver 31 and a GPS antenna 32, and is connected to camera 10 over the wired or wireless connection 40 as discussed above.

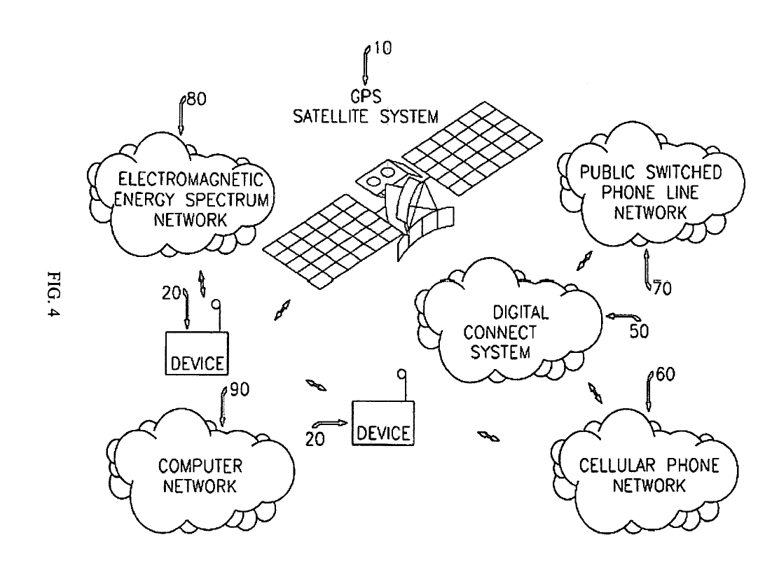

FIG. 3 is a flow diagram explaining process steps stored in a memory medium such as ROM 14, by which digital image data obtained by camera 10 is provided with data on time and location information stored with the image. Briefly, according to the exemplary embodiment FIG. 3, the process electronically captures the digital photograph into a digital camera file (102); receives position coordinate information, time, lens focal length, and camera direction including elevation/azimuth with each photograph (104); appends the position coordinate to the digital camera file (106); stores location information in one of: an image meta data and a separate meta data source such as HTML metatag fields, EXIF fields, IPTC fields, TIFF fields (108); displays the digital photograph as an image thumbnail placed at a location where the photograph was taken (110); and transmits the digital camera file over the Internet (112). Subsequent operations can occur based on image information and event information from the GPS-derived information captured by camera 10.

The digital camera 10 stores the image data in storage section, with the image data being stored in a file together with header information that includes the time and location information provided by GPS. The information can be stored as HTML metatags. In addition to HTML metatag encoding, time and positional information can be encoded in EXIF fields, IPTC fields, TIFF fields as well as Proprietary Maker Note fields from Canon, Casio, Epson, Minolta, Nikon, Olympus, Pentax and Adobe Photoshop Fields, among others. In one format for the digital camera image file, the image file includes digital image data in one section and a header section. The header section includes the GPS-derived data with time data and location data. Optionally, camera information including camera serial number, size and exposure information can be stored in the header section as well. Exemplary GPS fields include one or more of the following:

| | |
|---|---|
| gps-ver | RWS 0000 Version |

Values: Automatically generated

| gps-lat-ref | RWS 0001 Latitude Reference | | |
|---|---|---|---|
| Value | Abbrev | Num | Meaning |
| Values: north | n | . . . | North |
| south | s | . . . | South |

| | |
|---|---|
| gps-latitude | RWS 0002 Latitude |

Values: Latitude specified as either ‘dd mm.mm’ (eg. 45 27.50)
or as ‘dd mm ss’ (eg. 45 27 30)

| gps-long-ref | RWS 0003 Longitude Reference | | |
|---|---|---|---|
| Value | Abbrev | Num | Meaning |
| Values: east | e | . . . | East |
| west | w | . . . | West |

| | |
|---|---|
| gps-longitude | RWS 0004 Longitude |

Values: Longitude specified as either ‘ddd mm.mm’ (eg. 415 27.50)
or as ‘ddd mm ss’ (eg. 145 27 30)

| gps-alt-ref | RWS 0005 Altitude Reference | | |
|---|---|---|---|
| Value | Abbrev | Num | Meaning |
| Values: sea-level | 0 | 0 | Sea Level |
| below-sea-level | b | 1 | Below sea level |

| | |
|---|---|
| gps-altitude | RWS 0006 Altitude |

Values: A positive rational number

| | |
|---|---|
| gps-time | RWS 0007 Time |

Values: 3 positive rational numbers

| | |
|---|---|
| gps-satellite | RWS 0008 Satellite |

Values: Text string up to 1999 bytes long (or up to 49 in demo version)

| gps-recv-stat | RWS 0009 Receive Status | | |
|---|---|---|---|
| Value | Abbrev | Num | Meaning |
| Values: in-progress | a | . . . | Measurement in Progress |
| interop | v | . . . | Measurement Interoperability |
| gps-mode | RWS 000a Measurement Mode | | |
| Value | Abbrev | Num | Meaning |
| Values: 2d | 2 | . . . | Two-dimensional |
| 3d | 3 | . . . | Three-dimensional |

| | |
|---|---|
| gps-precision | RWS 000b Measurement Precision |

Values: A positive rational number

| gps-speed-unit | RWS 000c Speed Unit | | |
|---|---|---|---|
| Value | Abbrev | Num | Meaning |
| Values: kph | k | . . . | Kilometers per Hour |
| mph | m | . . . | Miles per Hour |
| knots | n | . . . | Knots |

| | |
|---|---|
| gps-recv-speed | RWS 000d Receiver Speed |

Values: A positive rational number

| gps-mov-dir-ref | RWS 000e Movement Direction Ref | | |
|---|---|---|---|
| Value | Abbrev | Num | Meaning |
| Values: true | t | . . . | True Direction |
| magnetic | m | . . . | Magnetic Direction |

| | |
|---|---|
| gps-mov-dir | RWS 000f Movement Direction |

Values: A positive rational number

| gps-img-dir-ref | RWS 0010 Image Direction Ref | | |
|---|---|---|---|
| Value | Abbrev | Num | Meaning |
| Values: true | t | . . . | True Direction |
| magnetic | m | . . . | Magnetic Direction |

| | |
|---|---|
| gps-img-dir | RWS 0011 Image Direction |

Values: A positive rational number

| | |
|---|---|
| gps-geodetic | RWS 0012 Geodetic Survey Data |

Values: Text string up to 1999 bytes long (or up to 49 in demo version)

| gps-dest-lat-ref | RWS 0013 Dest. Latitude Ref | | |
|---|---|---|---|
| Value | Abbrev | Num | Meaning |
| Values: north | n | . . . | North |
| south | s | . . . | South |

| | |
|---|---|
| gps-dest-lat | RWS 0014 Destination Latitude |

Values: 3 positive rational numbers

| gps-dest-long-ref | RWS 0015 Dest. Longitude Ref | | |
|---|---|---|---|
| Value | Abbrev | Num | Meaning |
| Values: east | e | . . . | East |
| west | w | . . . | West |

| | |
|---|---|
| gps-dest-long | RWS 0016 Destination Longitude |

Values: 3 positive rational numbers

| gps-dest-bear-ref | RWS 0017 Dest. Bearing Ref | | |
|---|---|---|---|
| Value | Abbrev | Num | Meaning |
| Values: true | t | . . . | True Direction |
| magnetic | m | . . . | Magnetic Direction |

| | |
|---|---|
| gps-dest-bear | RWS 0018 Destination Bearing |

Values: A positive rational number

| gps-dest-dist-ref | RWS 0019 Dest. Distance Ref | | |
|---|---|---|---|
| Value | Abbrev | Num | Meaning |
| Values: kilometers | k | . . . | Kilometers |
| miles | m | . . . | Miles |
| knots | n | . . . | Knots |

| | |
|---|---|
| gps-dest-dist | RWS 001a Destination Distance |

Values: A positive rational number

| | |
|---|---|
| gps-proc-method | RWS 001b Processing Method |

Not editable (data type UNDEFINED not supported for editing)

| | |
|---|---|
| gps-area | RWS 001c Area Information |

Not editable (data type UNDEFINED not supported for editing)

| | |
|---|---|
| gps-date | RWS 001d Datestamp |

Values: Text string 10 bytes long

| | |
|---|---|
| gps-diff-corr | RWS 001e Differential Correction |

Values: An integer in the range 0 to 65535

The flow diagram of FIG. 3 illustrating process steps on a memory medium such as ROM 14 or on disk in a personal computer (PC), by which the authenticity of image data and event data (time and location data) are verified. The process steps shown in FIG. 3 may be carried out in camera 10, but can be carried out in another device such as a personal computer that has access to file so (such as through transfer of such files from memory) and displays a map annotated with thumbnails of images at each location.

FIG. 4 shows an environment for a GPS enabled camera system that annotates each image with GPS coordinates. The camera system 220 can communicate using the electromagnetic energy spectrum, traditional computer networks, cellular phone networks, public telephone networks, and satellite system networks. The camera system 220 can communicate over one or more of the following: a cellular phone network 260, a standard phone line network 270, an electromagnetic energy spectrum network 280 and/or a computer network 290. The camera's GPS receiver receives signals from a GPS satellite system 210.

While the invention is described above with respect to what is currently considered its preferred embodiments, it is to be understood that the invention is not limited to that described above. To the contrary, the invention is intended to cover various modifications and equivalent arrangements included within the spirit and scope of the appended claims.

What is claimed is:

1. A method for annotating a digital photograph, comprising:
record global positioning system (GPS) information, time, lens focal length, and camera direction including elevation/azimuth with each photograph; and
processing the photograph based on the GPS information.

2. The method of claim 1, comprising:
electronically capturing the digital photograph into a digital camera file;
receiving a position coordinate;
appending the position coordinate to the digital camera file; and
displaying the digital photograph based on the position coordinate.

3. The method of claim 1, comprising showing the digital photograph along with a location corresponding to the position coordinate.

4. The method of claim 1, comprising graphically showing the location where each photo was taken.

5. The method of claim 1, comprising displaying the digital photograph on a map.

6. The method of claim 1, comprising displaying the digital photograph as an image thumbnail placed at a location where the photograph was taken.

7. The method of claim 1, comprising storing location information in one of: an image meta data and a separate meta data source.

8. The method of claim 1, comprising extracting location information in one of: an image meta data, a separate meta data source.

9. The method of claim 1, comprising storing the position coordinate in one or more of HTML metatag fields, EXIF fields, IPTC fields, TIFF fields.

10. The method of claim 1, comprising uploading the digital camera file to a remote computer.

11. An apparatus for annotating a digital photograph, comprising:
means for electronically capturing the digital photograph into a digital camera file;
means for receiving a position coordinate information, time, lens focal length, and camera direction including elevation and azimuth with the photograph;
means for appending the position coordinate information to the digital camera file and
means for displaying the digital photograph based on the position coordinate.

12. The apparatus of claim 11, comprising means for showing the digital photograph along with a location corresponding to the position coordinate.

13. The apparatus of claim 11, comprising means for graphically showing the location where each photo was taken.

14. The apparatus of claim 11, comprising means for displaying the digital photograph on a map.

15. The apparatus of claim 11, comprising means for displaying the digital photograph as an image thumbnail placed at a location where the photograph was taken.

16. The apparatus of claim 11, comprising means for storing location information in one of: an image meta data and a separate meta data source.

17. The apparatus of claim 11, comprising means for extracting location information in one of: an image meta data, a separate meta data source.

18. The apparatus of claim 11, comprising means for storing the position coordinate in one or more of HTML metatag fields, EXIF fields, IPTC fields, TIFF fields.

19. The apparatus of claim 11, comprising means for transmitting the digital camera file over the Internet.

20. The appartus of claim 11, comprising means for uploading the digital camera file to a remote computer.
